(19) United States
(12) Patent Application Publication
(10) Pub. No.: US 2015/0278713 A1
(43) Pub. Date: Oct. 1, 2015

(54) METHODS, SYSTEMS AND PROCESSORS FOR MANAGING A BOOKING FOR CHILD CARE

(71) Applicant: Kindy Now Pty Ltd, Elwood (AU)

(72) Inventors: Sean COLLINS, Elwood (AU); Matt MAYER, Hong Kong (HK)

(21) Appl. No.: 14/529,586

(22) Filed: Oct. 31, 2014

(30) Foreign Application Priority Data
Mar. 27, 2014 (AU) 2014100301

(51) Int. Cl. G06Q 10/02

(52) U.S. Cl. CPC G06Q 10/02

(57) ABSTRACT

A processor for managing a booking for child care. The processor includes a microprocessor, a memory, and a communications interface for providing access to a communications conduit. The memory includes instructions executable by the microprocessor such that the processor is operable to receive via the communications interface booking cancelation information, the booking cancelation information being indicative of cancelation of the booking for child care, send to a plurality of personal computing devices via the communications interface child care availability information indicative of the availability of child care from the start time of the cancelled booking, receive from one of the plurality of personal computing devices via the communications interface booking request information indicative of a request for child care from the start time of the cancelled booking for child care, and modify booking data stored in at least one of the memory and another memory using the booking request information.

### RELATED APPLICATION

The present application claims priority to Australian Innovation Patent No. 2014100301, filed Mar. 27, 2014, the disclosure of which is hereby incorporated by reference herein in its entirety.

### TECHNICAL FIELD

The disclosure herein generally relates to methods, systems and processors for managing a booking for child care.

### BACKGROUND

The management of bookings for child care, may if not efficiently managed, impact on the child care provider's profitability and/or viability. A booking cancelation may be burdensome for child care providers. A booking may be cancelled because a child is sick. The child's sickness may be discovered a short time before the booking, for example the morning of the booking. An available time for child care made available by a booking cancellation may not be ordinarily filled, especially if the cancellation is received a short time before the time slot, for example on the day of the booking.

To overcome this problem, a child care provider, for example child care center management, may phone many people to offer child care during an available time for child care. There are generally several problems with this approach, however:
Generally, only a small proportion of people contacted may be interested, and consequently attempting to fill an available time by making phone calls is generally unproductive and expensive.
Soliciting by phone calls may be perceived to be intrusive and/or unprofessional, which may reduce goodwill and reduce success.
The closer the available time is, the less time there is to contact potential clients and customers (for example parents), and the greater the chance the potential clients and customers have other engagements. Consequently, available times that are in the near future may be difficult to fill by making phone calls.
If most of the child care provider's time is booked, the child care provider and/or staff may be near fully occupied and thus generally unavailable to make phone calls to fill the small number of available times. Consequently, it may be very difficult to fill the last remaining available times.
The cancellation may be received at an unusual time, for example early in the morning when a child is discovered sick, and the child care provider may not be available to receive the cancellation and solicit a new booking.

Providing better methods, systems and processors for managing a booking for child care, for example a booking for care of a child at a child care center may be advantageous.

### SUMMARY

Disclosed herein is a method for managing a booking for child care. The method comprises the step of a processor receiving booking cancelation information, the booking cancelation information being indicative of cancelation of the booking for child care. The method comprises the step of the processor sending to a plurality of personal computing devices child care availability information indicative of the availability of child care from the start time of the cancelled booking. The method comprises the step of the processor receiving from one of the plurality of personal computing devices booking request information indicative of a request for child care from the start time of the cancelled booking, the processor subsequently modifying booking data stored in memory using the booking request information.

In an embodiment, the booking for child care is for child care at a child care center. The availability information may be indicative of child care so made available at the child care center from the start time of the cancelled booking. The booking request information indicative of a request for child care may be indicative of a request for child care at the child care centre. The processor subsequently modifying child care booking data may comprise the step of the processor subsequently modifying child care center booking data in memory using the booking request information to indicate that a user of the one of the plurality of personal computing devices has booked child care at the child care center from the start time of the cancelled booking and so filled the child care made available by the cancelation of the booking.

Filling an available time for child care made available by a booking cancelation may be automated. It may be otherwise difficult to fill the available time in view of labour and time costs for contacting potentially interested clients and customers (for example parents and guardians), especially if the cancellation is received a short time before the available time. Users may be able to remotely book child care at “the last minute”. The cancelled booking may not be refunded, and a charge may be made for the booking request. Consequently, booking cancellations may make, instead of loose, money.

In an embodiment, the booking request information is generated by the user interacting with the one of the plurality of personal communication devices. Each of the plurality of personal communication devices may have a user interface for the user to interact with, and an application that configures the user interface. The interface may be configured to display child care availability information. The booking information may be sent by one of the plurality of personal computing devices to the processor via a communications conduit. The communications conduit may comprise a network. The network may comprise the Internet. The processor sending and receiving may be via a communications interface of the processor that provides access to the communications conduit. The communications interface may comprise a network interface.

Bookings may be made at generally any suitable location and time, especially in examples wherein the plurality of personal computing devices comprise at least one of a smart phone and a tablet computer.

In an embodiment, the processor sends to the plurality of personal computing devices the child care availability information no earlier than a predetermined time. The predetermined time may be within one week of the time the child care starts. The predetermined time may be within 3 days of the time the child care starts. The predetermined time may be within 24 hours of the time the child care starts. The predetermined time may be within 1 hour of the time the child care starts.

In an embodiment, the plurality of personal computing devices may be associated with a plurality of children. The plurality of children may be registered with a provider of the child care. The processor may select the plurality of children from registered child data stored in a memory. The processor may have a child selection module for the selection of the plurality of children. The registered child care data may be indicative of another plurality of children registered with the provider of the child care.

The processor may select the plurality of children using a child selection rule. The child care availability information may only be sent to the personal computing devices of appropriate users. For example, only parents with a child that is of the right age for child care starting at the time, or have made expressions of interest for child care at that start time or consistent with the start time.

In an embodiment, the child care availability information comprises incentive information indicative of an incentive for making a request for child care to start at a child care provider preferred time.

In an embodiment, the processor provides an incentive for the receipt of the booking cancellation information. The incentive may be for the receipt of the booking cancellation information from a personal computing device.

In an embodiment, the step of the processor modifying booking data stored in memory comprises the step of the processor subsequently modifying booking data stored in a memory of the processor or another memory. The processor may be in communication with another processor and the other memory may be that of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format.

Disclosed herein is a processor for managing a booking for child care. The processor comprises at least one microprocessor, a memory, and a communications interface for providing access to a communications conduit. The memory comprises instructions executable by the at least one microprocessor such that the processor is operable to:

receive via the communications interface booking cancelation information, the booking cancelation information being indicative of cancelation of the booking for child care;

send to a plurality of personal computing devices via the communications interface child care availability information indicative of the availability of child care from the start time of the cancelled booking;

receive from one of the plurality of personal computing devices via the communications interface booking request information indicative of a request for child care from the start time of the cancelled booking for child care; and

modify booking data stored in at least one of the memory and another memory using the booking request information.

In an embodiment, the booking for child care is for child care at a child care center. The booking cancelation information may be indicative of cancelation of the booking for child care at the child care center. The cancellation of the booking may make available child care at the child care center. The child care availability information may be indicative of child care so made available at the child care center from the start time of the cancelled booking. The booking data may be child care center booking data. The child care center booking data may be modified to indicate that a user of the one of the plurality of personal computing devices has booked child care at the child care center from the start time of the cancelled booking and so filled the child care made available by the cancellation of the booking.

In an embodiment, the plurality of personal computing devices are associated with a plurality of children. The plurality of children may be registered with the provider of the child care. The processor may be arranged to select the plurality of children from registered child data stored in at least one of the memory and another memory. The processor may be arranged to select the plurality of children using a child selection rule. The processor may have a child selection module for the selection of the plurality of children. The registered child care data may be indicative of another plurality of children registered with the provider of the child care.

In an embodiment, the communications interface is a network interface. The communications conduit may comprise a network. The network may comprise the Internet.

Each of the plurality of personal communication devices may have a user interface and an application for configuring a user interface for an associated user to interact with.

In an embodiment, the child care availability information comprises incentive information indicative of an incentive for making a request for child care to start at a child care provider preferred time.

In an embodiment, the processor is operable to provide an incentive for the receipt of the booking cancellation information. The incentive may be for the receipt of the booking cancellation information from a personal computing device.

In an embodiment, the processor is operable to be in communication with another processor and the other memory may be that of the other processor. The processor may be operable to be in communication with the other processor via an application program interface (API). The other processor may have program instructions for child care management. The API may be defined by the child care management program instructions. The API may define hyper text transfer protocol requests. The API may define the transfer of information in Java Script Object Notation (JSON) format.

Disclosed herein is a method for managing a booking for child care at a child care center. The method comprising the step of a user interacting with a personal computing device to generate booking cancellation information indicative of cancelation of the booking for child care, and the personal computing device sending the cancellation information indicative of cancelation of the booking for child care to a processor. The method comprises the step of each of a plurality of personal computing devices receiving from the processor child care availability information indicative of the availability of child care from the start time of the cancelled booking for child care, the child care availability information being for display on a plurality of electronic displays of the plurality of personal computing devices. The method comprises the step of another user interacting with one of the plurality of personal computing devices to generate booking request information indicative of a request for the child care from the start time of the cancelled booking, and the one of the plurality of personal computing devices subsequently sending the booking request information to the processor.

An embodiment comprises the step of the booking request information being sent to the processor for the processor to modify booking data stored in memory using the booking request information. The booking data may be modified to indicate that the other user has booked for child care from the start time of the cancelled booking.

In an embodiment, the processor modifies the booking data stored in memory using the booking request information. The processor may be in communication with another processor and may modify booking data stored in a memory of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format.

An embodiment comprises the step of an application on the personal computing device and the plurality of personal communication devices configuring a user interface.

In an embodiment, the cancellation information and the booking request information may be sent, and the child care availability information may be received, via a communications conduit. The communications conduit may comprise a network. The network may comprise the Internet. The processor sending and receiving may be via a communications interface of the processor that provides access to the communications conduit. The communications interface may comprise a network interface.

In an embodiment, the plurality of personal computing devices are associated with a plurality of children. The plurality of children may be registered with the provider of the child care. The processor may select the plurality of children from registered child data stored in a memory. The processor may select the plurality of children using a child selection rule. A child selection module of the processor may select the plurality of children. The registered child care data may be indicative of another plurality of children registered with the provider of the child care. The booking request information may be sent to the processor for the processor to modify child care booking data stored in memory to indicate that the other user has booked for child care from the start time of the cancelled booking.

In an embodiment, the child care availability information comprises incentive information indicative of an incentive for making a request for the child care to start at the child care provider preferred time.

In an embodiment, the processor provides an incentive for the receipt of the booking cancellation information. The incentive may be for the receipt of the booking cancellation information from a personal computing device.

Disclosed herein is a system for managing a booking for child care at a child care center. The system comprises a personal computing device and a processor arranged to communicate with each other, the personal computing device being arranged for a user to interact therewith to generate booking cancellation information indicative of cancelation of the booking for child care, the personal computing device being arranged to send the cancellation information indicative of cancelation of the booking for child care to the processor. The system comprises a plurality of personal computing devices, the plurality of personal computing devices being each arranged to receive from the processor child care availability information indicative of the availability of child care from the start time of the cancelled booking for child care, and each of the plurality of personal computing devices are further arranged to display the child care availability information on an electronic display thereat. Each of the plurality of personal computing devices are arranged for an associated user interacting therewith to generate booking request information indicative of a request for child care from the start time of the cancelled booking, and subsequently send the booking request information to the processor.

An embodiment comprises the processor. The processor may be arranged to modify booking data stored in a memory using the booking request information. The processor may be in communication with another processor and the memory may be that of the other processor. The processor and the other processor may be in communication via an application program interface (API). The other processor may have program instructions for child care management. The API may be defined by the child care management program instructions. The API may define hyper text transfer protocol requests. The API may define the transfer of information in JSON format. In an embodiment, the personal computing device and the processor are arranged to communicate with each other over a communications conduit. The communications conduit may comprise a network. The network may comprise the interne. The processor may comprise a communications interface. The communications interface may comprise a network interface.

Each of the plurality of personal communication devices may have a user interface and an application for configuring the user interface for an associated user to interact with.

In an embodiment, the plurality of personal computing devices are associated with a plurality of children. The plurality of children may be registered with a provider of the child care. The processor may select the plurality of children from registered child data stored in at least one of the memory and another memory. The processor may have a child selection module for the selection of the plurality of children. The registered child care data may be indicative of another plurality of children registered with the provider of the child care.

In an embodiment, the child care availability information comprises incentive information indicative of an incentive for making a request for the child care to start at a child care provider preferred time.

In an embodiment, the processor provides an incentive for the receipt of the booking cancellation information. The incentive may be for the receipt of the booking cancellation information from a personal computing device.

Disclosed herein is processor readable tangible media including program instructions which when executed by a processor causes the processor to perform a method disclosed above.

Disclosed herein is a computer program for instructing a processor, which when executed by the processor causes the processor to perform a method disclosed above.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an embodiment of a processor for managing a booking for child care within an embodiment of a system for managing a booking for child care.

FIG. 2 shows a flow chart of an embodiment of a method for managing a booking for the child care.

FIG. 3 shows yet another embodiment of a processor for managing a booking for child care within another embodiment of a system for managing a booking for child care.

FIG. 4 shows information generated by the processor of either one of FIG. 1 and FIG. 3.

FIG. 5 shows a flow chart of another embodiment of a method for managing a booking for the child care.

FIGS. 6 to 16 are screen shots of a user interface of a personal computing device.

### DESCRIPTION OF EMBODIMENTS

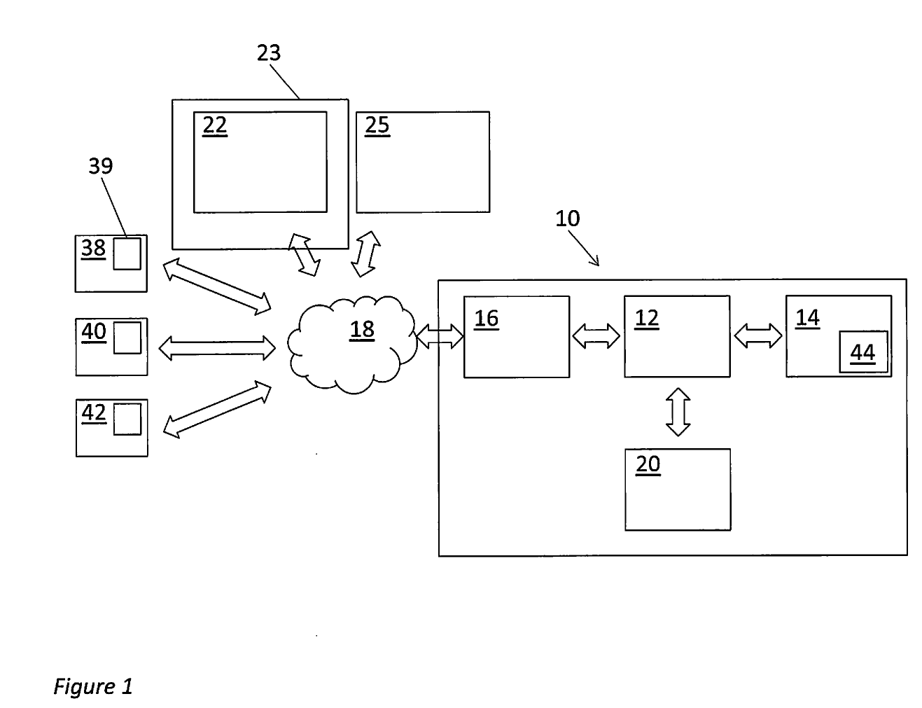

FIG. 1 shows an embodiment of a processor for managing a booking for child care, the processor being generally indicated by the numeral 10. In this but not necessarily in all embodiments, the booking for child care is a booking for child care at a child care center. The processor 10 has a microprocessor 12, memory 14, and a communications interface 16 for providing access to a communications conduit in the form of a computer network 18. The network 18 in this example is the internet 18.

A plurality of personal computing devices 38, 40, 42 are each configured to communicate with the processor 10 via the network 18. While three personal computing devices are shown in FIG. 1, there may be less (for example 2) or more (for example one of at least 50, 100 and 500). The plurality of personal computing devices are generally remote of the processor 10 and are operable by a plurality of users to manage bookings for the child care.

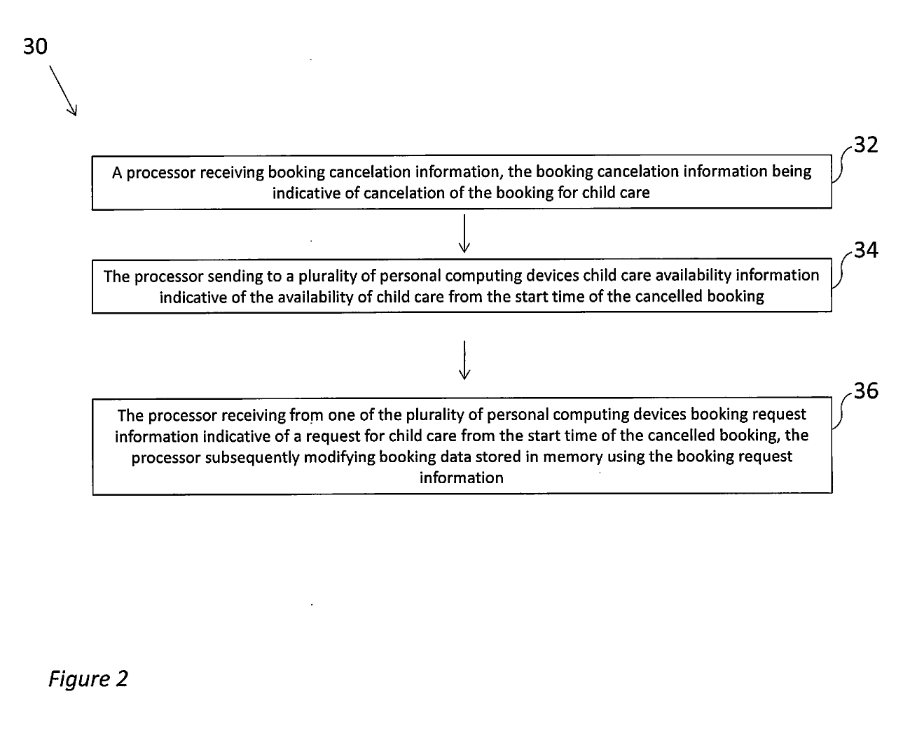

The memory 14 of the processor 10 has instructions executable by the microprocessor 12. When the processor 10 executes the instructions, the processor 10 is operable to perform the steps of an embodiment of a method 30 represented by the flow chart of FIG. 2.

In one step 32 of the embodiment of the method 30, the processor 10 receives booking cancelation information indicative of cancelation of the booking for child care. In this but not necessarily in all embodiments, the booking cancelation information is received via the network interface 18. The booking cancellation information is, in this but not all embodiments, generated by a user interacting with the one of the plurality of personal communication devices—say that indicated by numeral 38—and is sent by the one of the plurality of personal communication devices 38 to the processor 10 via the network 18. In alternative embodiments, the booking is cancelled via telephone and the child care provider provides the booking cancellation information to the processor, for example via a web browser interface or generally any suitable method. Generally the booking cancellation information may be received via any suitable method.

In this but not necessarily in all embodiments and prior to step 32, the processor 10 sends booking information to at least one of the plurality of personal computing devices 38, the booking information being indicative of at least one booking for child care. The sent booking information is generally but not necessarily for display by the at least one of the plurality of personal computing devices 38 to the user. The users may then interact with the personal computing device to cancel the booking as mentioned above. Alternatively, the user may know of the booking by some other means (for example, remember that they made a booking over the telephone previously).

In another step 34, the processor 10 sends to a plurality of personal computing device (in this embodiment devices 40 and 42 but in other embodiments additional personal computing devices not shown in FIG. 1) child care availability information indicative of the availability of child care from the start time, or during a period of, the cancelled booking. The availability information may be indicative of child care so made available at the child care center from the start time of the cancelled booking. The original booking may have been for, for example, child care from 9 am to 12 pm on a Monday, in which case the period of the cancelled booking is 9 am to 12 pm on the Monday, and the start time is 9 am. The request is generally in response to the sending of the child care availability information. In this but not necessarily in all embodiments, the child care availability information is sent via the network interface 18.

In another step 36, the processor 10 receives from one of the plurality of personal computing devices 40 booking request information indicative of a request for child care from the start time or during the period of the cancelled booking. The request is generally in response to the sending of the child care availability information, which is generally displayed by the personal computing devices to the users. The booking request information is, in this but not all embodiments, generated by a user interacting with the one of the plurality of personal communication devices 40 and is sent by the one of the plurality of personal communication devices 40 to the processor 10 via the network 18. The booking request information indicative of a request for child care may be indicative of a request for child care at the child care center.

The request information may be indicative of the start time or period of the cancelled booking in various ways. For example, the request information may include booking identification information that is used by the processor to look up at least one of the start time and the end time in a table stored in memory. Alternatively, the request information may include time data having at least one of the start time and the end time of the period. Generally the start time or period of the cancelled booking may be indicated in any suitable way.

In addition to the booking request information from one of the plurality of personal computing devices there may be further booking request information from at least one other of the plurality of personal computing devices. The first received booking request information generally has priority. The processor 10 generally subsequently modifies booking data 44 stored in the memory 14 to indicate that the user of the one of the plurality of personal computing devices has booked child care from the start time or during the period of the cancelled booking. In the example of child care, the booking data comprises child care center booking data. The booking request information is in this embodiment received via a network interface 16, however it may be alternatively received by a point-to-point wired connection or BLUETOOTH™ connection, for example, or generally any suitable connection.

The processor 10, in this but not necessarily in all embodiments, sends an email to the child care provider to notify them that a cancelation and/or a booking request has been made through it.

The booking data 44 may be stored in any one of a number of forms, examples of which include but are not limited to an array of record data structures, a sequence of containers, a doubly linked list of containers, and a database. The booking data may be indicative of at least one of the child associated with the user that has made a booking, the user that made the bookings, the period of the booking, and the start time of the booking, for example. The instructions in the memory 14 include data base queries to retrieve the relevant records for processing, and field modification instructions to change the data to reflect changes to the bookings and time slots, for example at least one of the child booked in, the user that made the booking, the period of the booking, and the start time of the booking. Generally, the booking data is modified to indicate that the user of the one of the plurality of personal computing devices has booked for child care from the start time of the cancelled booking. The data base may be implemented in any suitable manner, for example by purpose written code in a language such as C++ or PYTHON, or using existing data base software installed on the processor 10. In the present examples, the data base software is a NoSQL database using MongoDB™. Alternatively, the data base software may be SQL or any other suitable type of database. An application program interface may provide access to the database. In embodiments using a relational data base structure, the relational database structure has a plurality of tables. For example, the database may have a child details table. The database may have a table for responsible persons. The database may have a table for child care time slots. The database may have a table for the location of the child care (e.g. a room) within the child care center.

In this but not necessarily in all embodiments, the booking data 44 is child care center booking data. The child care center booking data may be indicative of a period in which child care is provided at the child care center. The child care center booking data may be indicative of a plurality of people (i.e. children) booked for child care during the period at the child care center. The child care center booking data may be indicative of a location, for example a room, in which the child care is provided.

There may be more than one cancelled booking for a time slot. The embodiments described herein are applicable to the case of more than one cancelled booking for a time slot.

The users are generally persons responsible for the plurality of children, for example parents and guardians. In this but not necessarily in all examples, the plurality of children are registered with a child care center 23. The details of the plurality of children are stored in the memory 14, as is personal computing device identification information (for example, a phone number of the personal computing device in the case it is a smart phone, and/or the login details entered through a personal computing device). Each child is associated with personal computing device identification information by, for example, putting child details and identification information for a personal computing device in the same data base record or by some other way.

The method 30 may generally be used to cancel a booking for any one of the children registered with the child care center and offer to other users care of any other child registered with the child care center from the start time or during the period of the cancelled booking.

The processor 10 in this but not necessarily in all embodiments executes a child selection rule to select the plurality of children from registered child data stored in the memory 14. The processor, in this but not necessarily in all embodiments, has a child selection module for the selection of the plurality of children. The registered child data is indicative of another plurality of children registered with the child care center, for example the other plurality of children may be all of the children registered at the child care center. The selection rule may be, for example “The plurality of children are those in the same age group as that of the child whose booking was cancelled”, or “The plurality of children are those that have indicated they are interested in child care on a predetermined day of the week”. Another example of a selection rule is “The plurality of children are those that have attended the room in the child care center associated with the cancelled booking”. The child who takes the cancelled booking may be more familiar with the child care workers and the other children in the room, which reduced stress for the child and enhances the child care experience. Generally any suitable selection rule may be used. The selection rule may take the form of, for example, a query of the database 44 (which in this embodiment includes registered child data), which may take the form of a Boolean expression including field identifiers.

The processor 10 is, in this embodiment, located remote from a child care center. A child care center computing device 22 associated with the child care center 23 is generally, but not necessarily, located at the child care center 23 and is in communication via the network 18 with the processor 10 and operable by a child care center representative, for example a child care center manager. In alternative embodiments, however, the processor 10 may be located at the child care center, in which case the processor may provide a user interface which may include for example an electronic display, a mouse and keyboard, or generally any suitable user interface. The user interface may be, for example, operated to instruct the child care center computing device 22 to display bookings, view details of user's children registered at the child care center, cancel a booking (including marking a child as being or will be absent), etc. The child care center representative may operate the computing device 22.

In this embodiment, the user that interacts with the one of the plurality of personal communication devices 38 to generate the booking cancelation information does not receive a refund for the cancelled booking.

The user that interacts with the one of the plurality of personal communication devices 38 to generate the booking cancelation information, in this but not all embodiments, is provided with an incentive to do so. The incentive is in the form of a donation to a charity, however any suitable incentive may be provided, for example a payment to the user that is less than the cost of the child care. The donation or payment may have a value of a few dollars or generally any suitable value.

The other user that interacts with the other one 40 of the plurality of personal computing devices 38 to generate booking request information is, in this but not necessarily in all embodiments, charged for the booking. That is, the cancelled booking is resold. The processor 10 is arranged to debit an account of the other user, for example a credit card account. This may be by, for example, an account in the memory 14 of the processor 10, which subsequently generates and sends an invoice to the other user, or by communicating with a banking system via the network 18. The account may be a credit card account. There is a financial gain when the booking is resold. The processor may be arranged to credit an account of the child care provider with the amount debited to the account of the other user. This financial gain is not generally realised when a booking is cancelled and another booking made over, for example, the telephone. As described above, the processor 10 provides incentives for the users to cancel bookings using their personal computing device, which may increase the number of resold bookings and consequently profits.

In other embodiments, however, the user that generates the booking cancellation information does receive a refund. The refund may be conditional on a refund condition being meet. For example, the refund condition may include, for example, at least one of:
the user generated the booking cancellation at least a minimum notice time before the booking, for example 1 week before the booking; and
the user is a participant in a flexible child care plan that allows refunds for cancellations.

### Processor

The processor 10 will now be described in more detail. The processor 10 stores instructions in memory 14. The memory 14 includes nonvolatile memory in the form of at least one of a hard disk drive, solid state memory, FLASH, EPROM or any other form of processor or computer readable tangible media within or external of the processor. The instructions generally, but not necessarily, comprise a plurality of software modules that cooperate when installed on the processor 10 so that the steps of embodiments of the methods may be executed. The software modules, at least in part, correspond to the steps of the method or modules of the systems described above. The functions or components may be compartmentalised into modules or may be fragmented across several software modules. The software modules may be formed using any suitable language, examples of which include C++ and assembly. The modules may comprise a plurality of threads running on the microprocessor 12—which may have more than one core. Inter module communication may be achieved using inter-process communication methods such as file sharing, signalling, sockets, message queues, pipes, memory sharing, message passing, memory-mapped file sharing, or any other suitable method or Application Program Interface. The microprocessor 12 may be any suitable micro processor, for example an INTEL XEON or AMD OPTERON micro processor connected over a bus to a volatile memory component of memory 14 in the form of random access memory of around 10 GB. An alternative embodiment has two or more microprocessors. The processor 10 has input/output interfaces 16 which includes a network interface in the form of a network interface card in this but not necessarily all embodiments, and a universal serial bus. In other embodiments the network interface may be in the form of a USB interface into which is received a USB modem dongle or a WiFi module. The communications interface 16 may comprise at least one of these network interfaces. The processor may support a human machine interface 20 that includes, for example, a mouse and a keyboard in communication with the universal serial bus, and a display in communication with a display port, for example. The processor 10 is in the form of a computer or computer server, examples of which include a Dell PowerEdge™ server and a personal computer. The processor may be a virtual server, for example an AMAZON™ server.

The instructions executable by the processor 10 are generally in the form of software, but may in some embodiments take the form of firmware or may be entirely hardware based. The processor may be configured by a single application.

In yet another embodiment, the processor runs two applications that communicate via an Application Program Interface (API). One of the applications may be, for example, existing child care management software “KIDSOFT” running on the processor 10 that provides some child care center management functions and is used by child care center representatives to enter and delete bookings, record child details, and track payments, for example. The other application runs on the same processor 10 and communicates with KIDSOFT software via the API and the personal communication devices 38-42 to provide the functionality described herein. The processor may comprise two machines, one having child care management software, the other having the other application communicating with the child care management software via an API and a network.

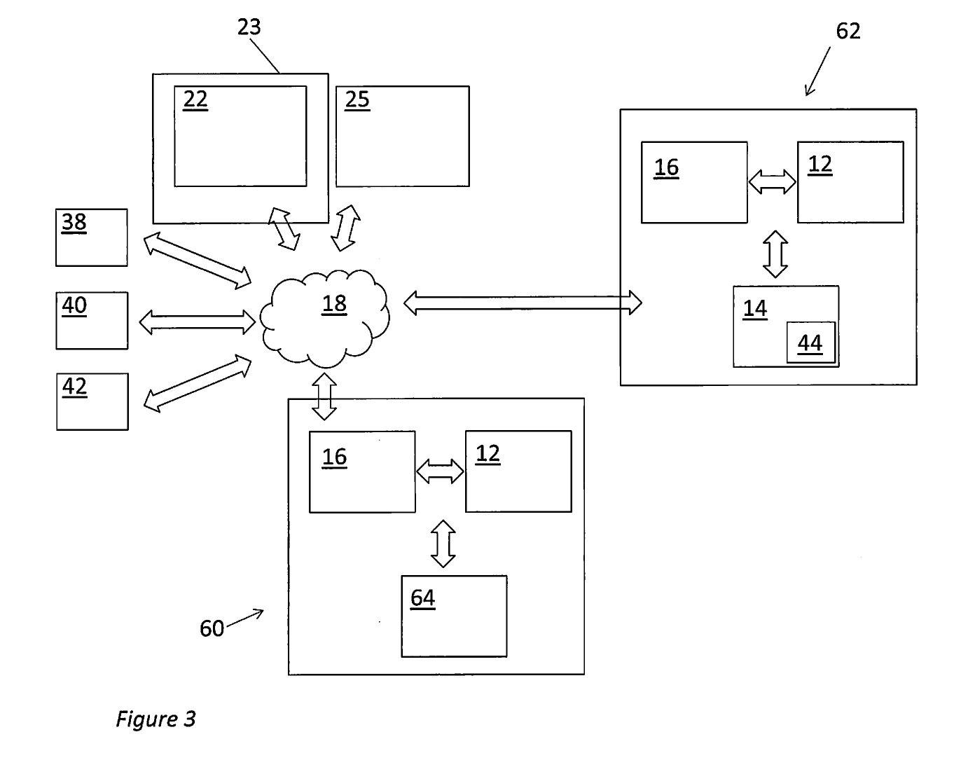

FIG. 3 shows another embodiment of the processor 60, where parts of similar form and/or function to those of FIG. 1 are similarly numbered. The processor 60 comprises a computer server that communicates with the plurality of personal computing devices 38, 40, 42 over the network 18. The processor 60 may be generally located anywhere and comprises a suitably programmed computer server (having the same general architecture as the processor 10, for example), however it may alternatively be a virtual computer server or machine provided by the AMAZON™ Elastic Compute Cloud (Amazon EC2), or generally any suitable computer server, or cluster of computer servers, whether virtual or otherwise.

The processor 60 is arranged to cooperate with another processor 62 in the form of another computer server. The server 60 and other server 62 are in this example operated by different entities and are located in different cities, and communicate via the Internet 18. They may, however, be operated by the same entity and in the same room and communicate via a local network 18. The other processor 62 may also be generally located anywhere and comprises a suitably programmed computer server, however it may alternatively be a virtual computer server. The server 62 has child care management software, for example “KIDSOFT”. The processor 60 executes the embodiments of the method of FIG. 2 or variants thereof as described with respect to the processor 10 of FIG. 1. The processor 60 has the same or similar structure to processor 10, however other embodiments may have different architectures. The details of parents and children registered with the child care center are stored in database 44 of memory 14 of the processor 62. The functions of processor 60 may be provided as an optional “plug in” to the existing child care management service provided by KIDSOFT, for example. Thus, the capabilities of the processor 62 may be augmented by processor 60 which provides hitherto unavailable functionality. The processor 60 may cache information received from the data base 44 in memory 64. Cached information may include, for example, registered center information indicative of a plurality of centers registered from the database 64, registered center phone number information indicative of the phone numbers of the plurality of centers, registered center name information indicative of the names of the plurality of centers, registered center capacity information indicative of the capacity and/or age group for each child care room in each of the plurality of centers (e.g., “red” room is for 1-2 year olds and can hold 10 children, “green” room is for 3-5 year olds and can hold 15 children, etc.), and registered child information indicative of the age and/or name and/or other details of the children registered with each of the plurality of child care centers. The processor 60 may also calculate information from information from the other processor 62 and/or cached in memory 64. For example, the processor 60 may request and receive from the other processor 64 information indicative of the number of children booked for a room at a selected time. Using this information, and cached information on the room capacity, the processor 60 may calculate how many places are available. Incentives to request a booking may be provided if there are a substantial number of free spaces.

In this embodiment, the processor 60 and other processor 62 communicate using an API provided by the child care management software, in the form of a hypertext transfer protocol (HTTP) API. A transmission control (TCP) session may be started between the processor 60 and the other processor 62, and on this layer a HTTP session or secure hypertext transfer protocol session (HTTPS) may commence between the processor 60 and other processor 62 (both HTTP and HTTPS are referred herein as HTTP for convenience). The API provided by the child care management software receive commands and requests using a HTTP POST or generally any suitable form of HTTP post or other request. Responses to commands and requests may be sent by the child care management software via the API in JSON format over the HTTP session. It will be appreciated that the API may take any suitable form, and may not use HTTP or JSON.

The API becomes active by the processor 60 sending via the HTTP session a security key in the form of a string of symbols to the processor 62 and the processor 62 confirming that the security key is a valid security key.

An example of a session in now described for the embodiment of the system shown in FIG. 3. A user inputs a mobile (or cell) phone number on their personal computing device 38 in communication with the processor 60. The phone number is sent to the processor 60 by the personal computing device. The processor 60 sends a request via the API to the other processor 62 to confirm that the mobile phone number is linked with a parent or guardian that is registered with a child care center. If confirmed by the other processor 62, the other processor 62 causes a confirmation code to be sent to the device 38 having the phone number via a short message service (SMS). The user may then input the confirmation code on their personal computing device which is subsequently sent to the processor 60. The processor 60 then sends the confirmation code and the phone number to the other processor 62. The processor 62 on receipt of a valid confirmation code and phone number combination provides an access token in the form of a plurality of symbols to the processor 60. The processor may subsequently use the access token to obtain details from the other processor 62 and change details on the other processor 62, the details being associated with the user, for example children registered with the child care center under the user's name, bookings, etc.

For example, the processor 60 may make the following POST request of the other processor 62, the request being for information indicative of bookings by a user between a start date and an end date:

https://app.kidsoft.com.au/api/v1/KindyNow/getBooking

The parameters of the POST request include, in this but not all examples, the API key, access token. The booking times (e.g. booking start time and/or booking end time) or booking identification information may be included, either of which are sufficient to determine the start time of the booking. The processor 62 may respond with, for example, symbols in JSON format, for example:

{“Bookings”: [ ],

### “Status”: “OK”}

The details of the bookings would generally be located between “[” and “]”. In this example, however, there are no bookings.

The processor 60, on receiving cancellation information, makes a POST request to change the status of the booking in the other processor 62 so that the child is marked as absent. Alternatively, the processor 60 may make a POST request to clear all user/child information from the booking, leaving it open again.

The processor may modify child care center booking data in memory using the booking request information to indicate that a user of the one of the plurality of personal computing devices has booked child care at the child care center from the start time of the cancelled booking and so filled the child care made available by the cancelation of the booking. For example, the processor 60, on receiving booking request information indicative of a request for child care from a start time of a cancelled booking, generally sends to the other processor 64 via the API a change booking request indicative of a change to the booking that has been cancelled. The replace booking request includes tokens for each of the user that cancelled and the user who made the request for child care, and the start time or other information indicative of the booking start time, for example booking information that uniquely identifies the booking time. The other processor 62, on receiving the replace booking request, changes the user associated with the booking from the user that cancelled to the user that made the request.

Generally, but not necessarily, the information, received and sent by the processor (or processors, depending on the embodiment) 10, 60, 62 and the plurality of personal computing devices comprise packets. The packets generally, but not necessarily, comprise, for example, a header, and a payload. The packets may also have a trailer. The packets may be structured in accordance with the Open Systems Interconnection Model or Internet Protocol Suite (IPS), in which each payload may be itself another packet of another layer of the OSI model or IPS. For example, at the physical layer the packet is a collection of bits. The physical layer packet may comprise a data link packet having a datalink header, a datalink payload and a datalink trailer. The datalink payload may in turn comprise a Network data packet such as an IP packet. The IP packet payload may comprise a TCP or UDP packet (“segment”). This layered structure may continue to the Application layer.

While some of the network connections described above may comprise optical and/or electrical Ethernet (for example 10 Mb, 40 Mb, 1 Gb, 10 Gb, 40 Gb, 100 Gb, 400 Gb, 1 Tb), it will be understood that other network types and protocols may be used, such as INFINIBAND, WiFi, and cellular networks and their protocols. Generally, any packet or non packet based protocol may be used. Alternatively or additionally, one or more of the network connections may alternatively be a serial port connection, a USB port connection, a FireWire™ port connection, a ThunderBolt™ port connection, a PCI or PCIe connection, a SONET (or SDH) connection with or without a sonnet demultiplexing device, or generally any suitable type of connection.

Other forms of processor may be used as suitable. For example, alternative logic devices may be used in place of the microprocessor 12. Examples of suitable alternative logic devices include application-specific integrated circuits, FPGAs, and digital signal processing units. Some of these embodiments may be entirely hardware based for further latency reduction. In another embodiment, the processor may comprise a networked plurality of computers or processors, or be a virtual machine within computer hardware. Generally, the processor may take any suitable form. The modules may comprise hardware modules.

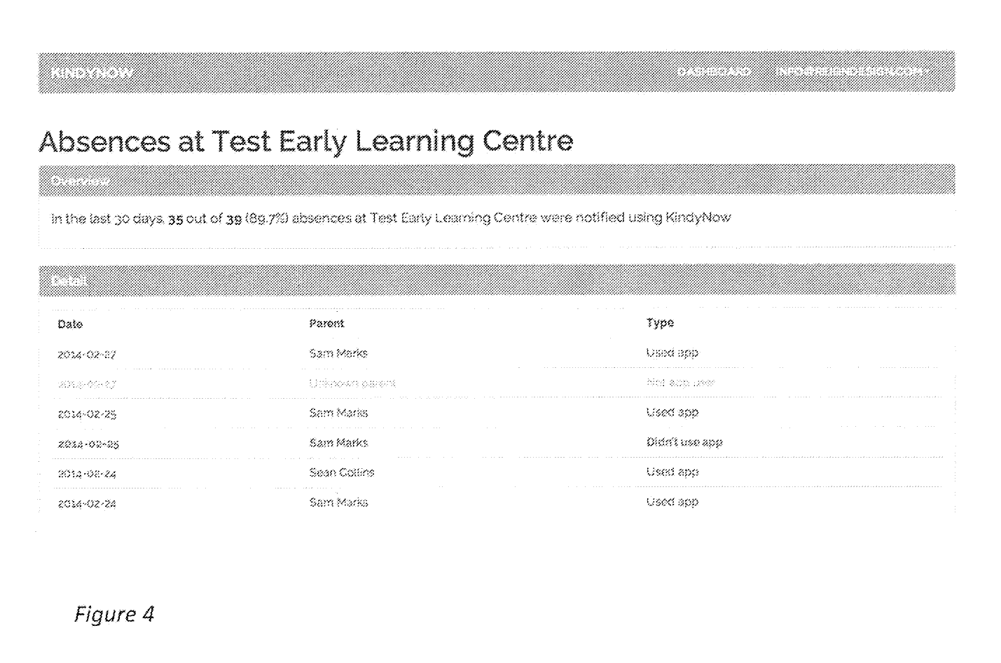

FIG. 4 shows a screen shot of the contents of a web browser window displayed by the child care center computing device 22, being a representation of information received from the processor 10, 60. The information is in the form of personal computing device usage information indicative of the usage of the plurality of personal computing devices to cancel bookings for child care. FIG. 4, for example, shows that a booking cancellation that was not requested by a personal computing device (“Didn't use App”). In some but not all embodiments, the processor 10, 60 is arranged to send a message by, for example, SMS or any other suitable channel to a user that cancelled a booking for child care through a channel other than the personal computing devices. The message may comprise information encouraging the user to use a personal computing device to cancel a booking in the future.

### Personal Computing Devices

The personal computing devices 38, 40, 42 may generally be any suitable personal computing device, examples of which include but are not limited to smart phones (for example an APPLE IPHONE or SAMSUNG GALAXY SII), and tablet computers (for example an APPLE IPAD, SAMSUNG GALAXY Tab3). In the example of FIG. 1, the personnel computing devices include at least one of a smartphone (personal computing devices 38 and 40) and a tablet computer (personal computing device 42). Generally, the personal computing devices each have a user interface in the form of a touch sensitive electronic display 39. Other examples may have a keypad and electronic display.

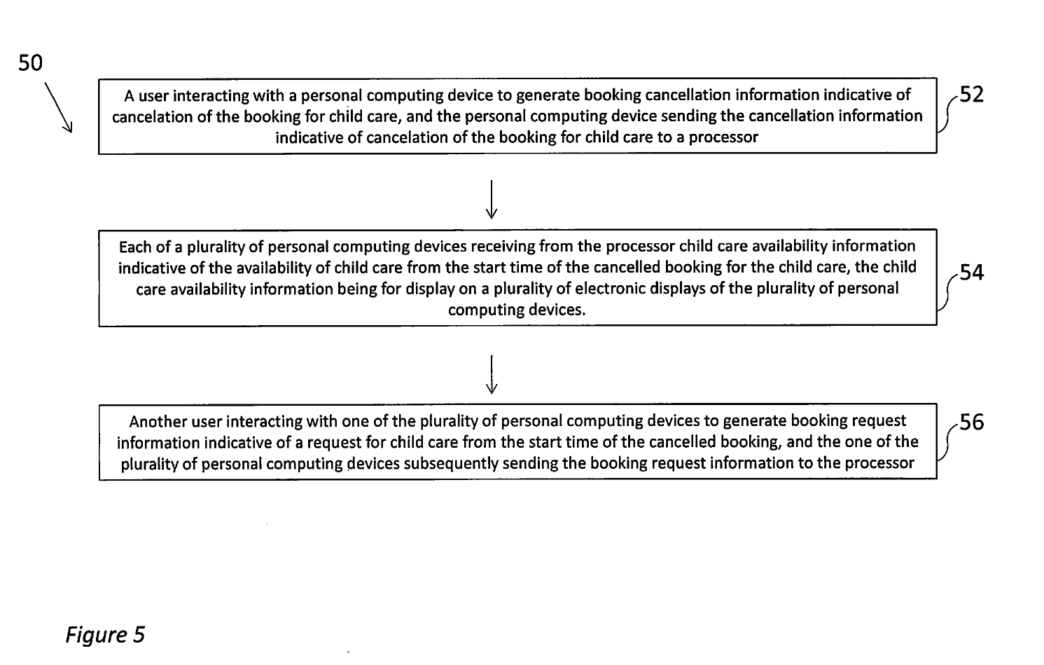

The personal computing devices are configured to connect to the processor 10, 60 via, for example, the communication conduit 18. The connection may include a 3G, 4G, WiFi or other wireless and/or wired network. In this but not necessarily in all embodiments, the personal computing devices are arranged to establish a transport control protocol (TCP) session with the processor 10, 60, and a HTTP session on the TCP layer. Information is generally exchanged between the personal computing devices and the processor 10 using HTTP requests GET and/or POST, with responses from the processor 10, 60 having response information in JSON format. Other protocols, formats, and physical connection types may be used as suitable. For example, UDP or SCTP sessions may be established instead, and proprietary application layer protocols employed. A user of a personal communication device 38, 40, 42 may download and install thereon an application in the form of, for example, an App from, for example, the Apple App or iTunes store, Google Play. The App may be started by a user of the personal communication device so that the user can interact remotely via the internet or other communication conduit with the processor 10, 60. When the App is running, the personal communication device is configured to take part in the execution of the example methods of FIGS. 2 and 5, for example.

The App may be built using IOS SDK, XCode, Android Studio, Android Software Development Kit “SDK” or APP INVENTOR, by Google Labs, for example, or generally any suitable environment and language.

Using the personal computing devices running the App, an embodiment of a method 50 shown in FIG. 5 may be executed. In one step 52, a user interacts with a personal computing device 38, 40, 42 to generate booking cancellation information indicative of cancelation of the booking for child care. The personal computing device 38 sends the cancellation information indicative of cancelation of the booking for child care to a processor 10, 60.

In another step 54, each of a plurality of personal computing devices 40,42 receive from the processor child care availability information indicative of the availability of child care from the start time or during the period of the cancelled booking. The child care availability information is sent for display on a plurality of electronic displays of the plurality of personal computing devices 40, 42.

In yet another step 56, another user interacts with one of the plurality of booking devices 40, 42 to generate booking request information indicative of a request for child care from the start time or during the period of the cancelled booking, and the one of the plurality of personal computing devices subsequently sending the booking request information to the processor 10.

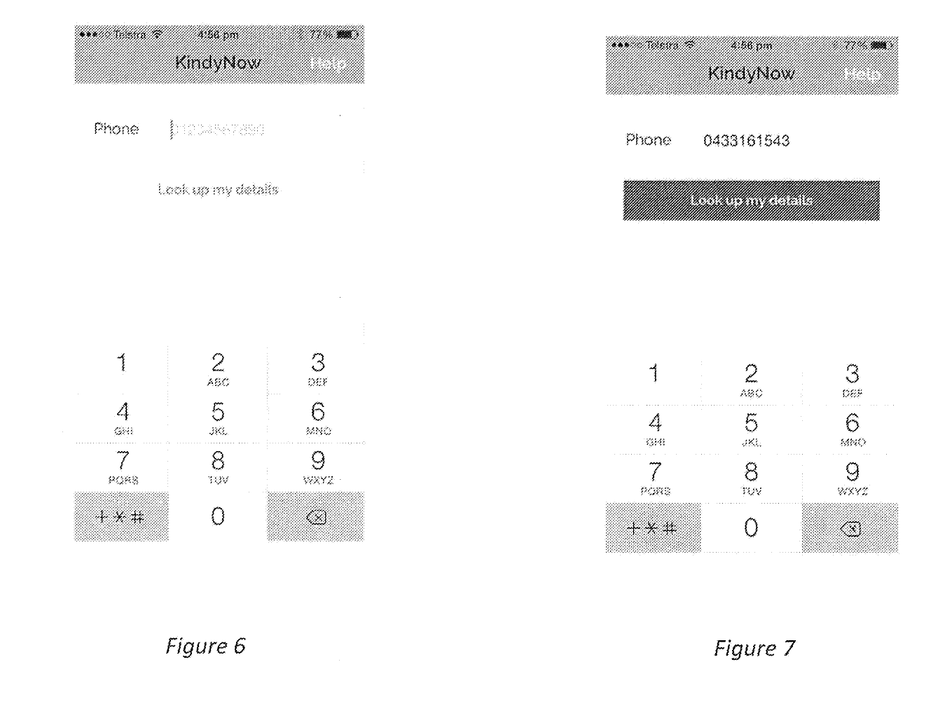

FIGS. 6 to 16 are screen shots of user interfaces in the form of touch screens of each of the plurality of personal computing devices 38, 40, 42 that are configured by the App thereon. At least some of the images displayed by the user interfaces may be generated during execution of the methods 30 and 50, for example. FIG. 6 shows a displayed keypad that enables the user to sign up by inputting their mobile phone number by touching a plurality of buttons displayed on the touchscreen.

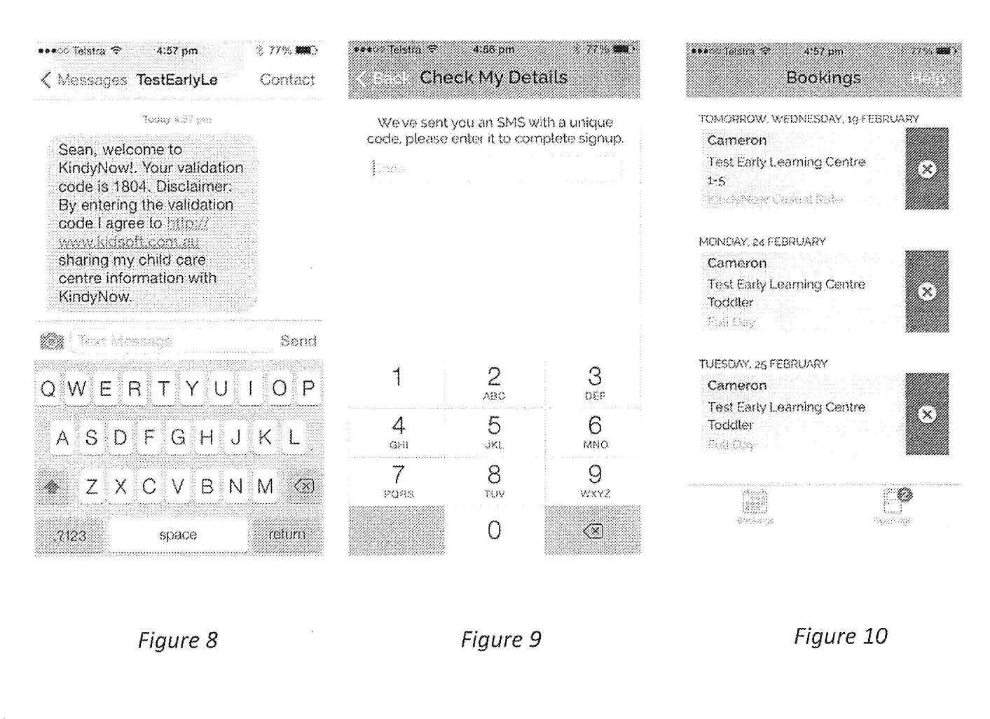

FIG. 7 shows an image displayed on the touch screen after the user enters the mobile phone number, the image confirming the connection between the personal computation device and the processor 10. FIG. 8 shows a user interface showing a validation code received by the personal computing device via SMS or another channel: The user is asked to enter the validation code to share child information with the processor 10. FIG. 9 shows a user interface that enables a user to type in the code to complete the sign up or registration process. FIG. 10 shows a user interface including displayed bookings data held by the processor 10, 60. In this but not necessarily in all examples, the user can cancel a booking of theirs by touching the screen at the position of a displayed cross associated (in this case adjacent) with the booking.

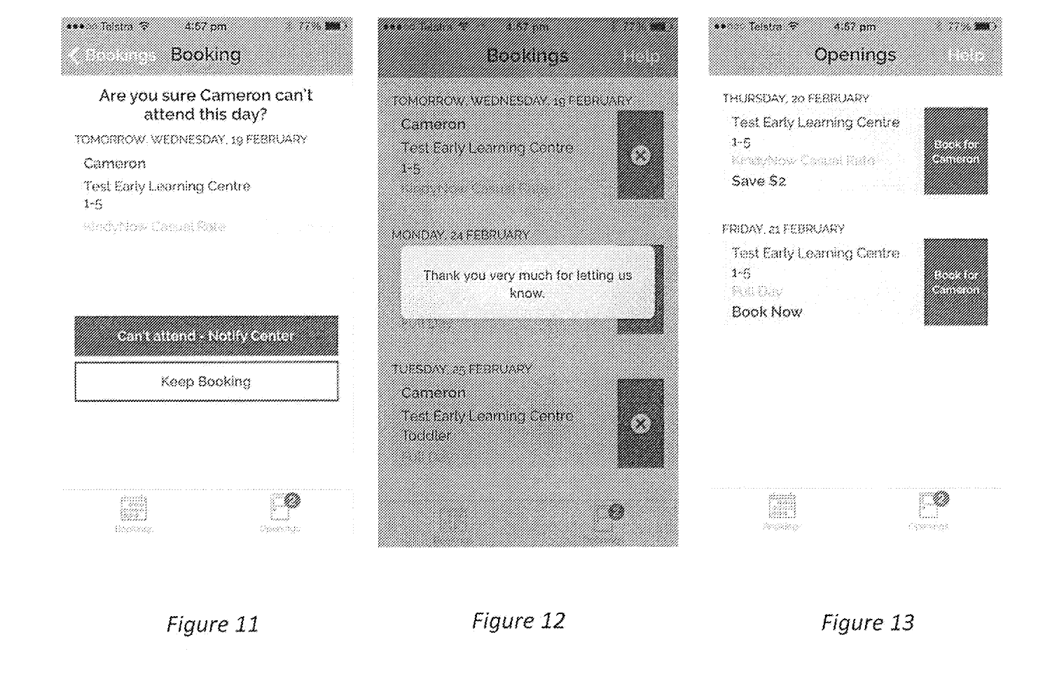

FIG. 11 shows a user interface presented during confirmation of the cancellation. The user can confirm cancelation by pressing a button, in this example, by touching the touchscreen at the displayed text “Can't attend—Notify center”. Alternatively, the user can cancel the cancelation request and so keep the booking by touching the touchscreen at the displayed text “Keep Booking”. FIG. 12 shows a displayed image wherein the personal communication device thanks the user for letting the child care center, via the processor 10, know that the booking is cancelled. The processor 10 then updates the booking data 44.

FIG. 13 shows a displayed image including displayed information indicative of available time slots for care of a child at the child care center. In this embodiment, the personal computing device is configured to only display information indicative of available time slots for days without a booking for the child. Incentives, for example in the form of a financial or other incentive, may be provided, in this example a discount of $2 is offered for a booking on Thursday 20 February. The incentives may, for example, entice a booking on a day on which demand is low, for example, or for which there have been cancellations. In this example, the child care availability information comprises incentive information indicative of the incentive for making a booking. For example, the incentive information may indicate which start time has an incentive attached. The incentive information in this but not all embodiments may indicate the value of the incentive. An available time for child care may be more likely to be filled when the incentive is provided. The quantity of incentive may be dependent on the quantity of time to the time child care starts. For example, an incentive may be provided for booking an available time in the near future (for example, within the predetermined time period). An incentive may not be provided for booking another available time not in the near future. Suitable incentives may include gifts of tangible and/or intangible goods, vouchers for discounts for other services, or generally any other suitable incentive.

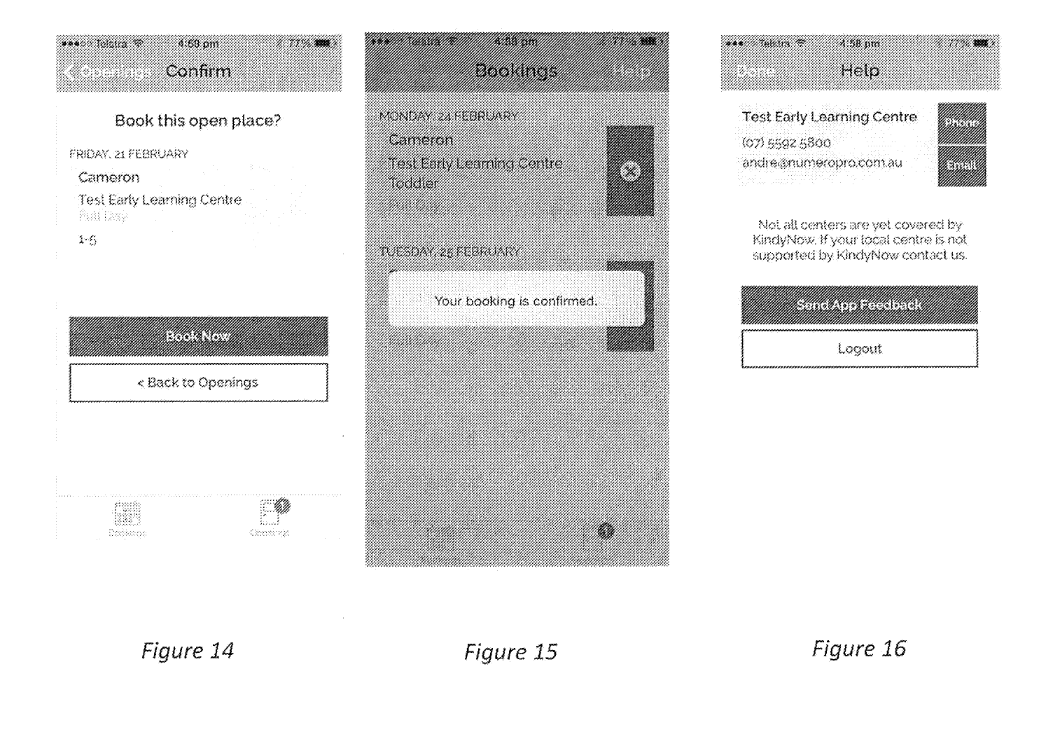

FIG. 14 shows a user interface presented when a user makes a booking at an available time slot. The user may press the “Book Now” button by touching the touchscreen at the text “Book now” to make the booking. FIG. 15 shows a displayed image advising the user that the booking is confirmed. FIG. 16 shows a displayed image of a “help” screen, which includes the user's child care center's phone number and/or email address.

In alternative embodiments, the processor 10 may receive the booking cancelation information via a message sent via a Short Message Service (SMS) of the type generally accessible on mobile and cell telephones. The processor may be connected via the internet 18 to a SMS server connected to a cellular network and configured to receive SMS messages and forward the message on to the processor 10. The processor 10 in this embodiment is configured to parse the received SMS to retrieve the cancelation information. Generally, the booking cancellation message may be generated and communicated to the processor 10 by any suitable method and the message may take any suitable form.

Alternatively, the personal computing device may be a personal computer (for example a personal computer running MICROSOFT WINDOWS or MAC OS), which may be, for example, a desktop or laptop personal computer. The personal computer has a user interface that may include, for example, an electronic display, a keyboard, a mouse and/or a touchpad. The user interfaces may be adjusted for use of these hardware interfaces rather than a touch screen.

### Child Care Center Computing Device

The child care center computing device 22 is, in this but not necessarily in all embodiments, in the form of a personal computer. In this but not necessarily in all embodiments, for example, the child care center computing device 22 has web browser software in the form of MICROSOFT INTERNET EXPLORER (although any suitable web browser may be used, further examples of which include CHROME, and FIREFOX). Operation of the web browser on the computing device 22 by the user may cause the computing device 22 to receive from the processor 10 information including current bookings for the care of children at the child care center and/or time slots for which there is currently no booking. The received information is generally displayable by the web browser on the child care center computing device 22.

The processor 10 serves, in the example of FIG. 1, a plurality of child care center computing devices 22, 25. The processor may serve more or less than two child care center computing devices 22, 25. Generally, each computing device 22, 25 is for a different child care center, however more than one child care center computing device may be for a particular child care center, for example one device 22 may be for management and another may be for reception.

In this but not necessarily in all examples, the child care center representative may view their own custom dashboard displayed by the computing device 22 which allows them to configure the processor 10. Configuration options include:
Offering discounts for bookings, for example, for last minute bookings which have been grouped by days out (eg. 1 day, 2-3 days and above 4 days);
Offer a discount for a user that has cancelled a booking;
Sending notifications to a user asking if their child is attending each day;
   The dashboard may also display:
Penetration: The number of parents that have downloaded an App onto their personal computing device to allow them to interact with the processor 10;
Absentees Notified: The number of bookings cancelled;
Bookings resold: The number of cancelled bookings filed;
Revenue: The revenue made from resold bookings; and
Detailed notifications: Time and parent who made the booking/cancellation.
   Now that embodiments have been described, it will be appreciated that some embodiments have some of the following advantages:
An available time for child care made available by a booking cancelation may be filed with little or no input by a child care provider representative, which may be otherwise difficult to fill, especially if the cancellation is received a short time before the time slot, for example on the same day as the time slot.
Cancelations because of sick children—a common occurrence in child care—may be filled and/or resold for profit.
The processor may react immediately when a booking is made or cancelled, for example, by notifying others of a vacancy.
Booking management is controlled by users (eg. parents and guardians) rather than the child care providers which previously has not been possible in the applicants best knowledge, which may be convenient for users.
The fact the users don't have to call the child care provider to make bookings during the child care provider representative's time (after hours even) may reduce labour and costs.
The changing of bookings is controlled by users rather than child care provider representatives. Not only may this reduce work for the child care provider, it may be convenient for users.
Incentives may be provided that increase child care provider profitability.
Users may check for notifications of time slots made available by a cancellation only when they are seeking child care, and not receive obtrusive offers by phone.

Variations and/or modifications may be made to the embodiments described without departing from the spirit or ambit of the invention. For example, the network may be a local area network or a wide area network. The plurality of children may be registered at a plurality of child care centers, and notification of available child chare at any one of the plurality of child care centers may be sent to the plurality of personal computing devices associated with the plurality of children. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method for managing a booking for child care, the method comprising the steps of:
a processor receiving booking cancelation information, the booking cancelation information being indicative of cancelation of the booking for child care;
the processor sending to a plurality of personal computing devices child care availability information indicative of the availability of child care from the start time of the cancelled booking; and
the processor receiving from one of the plurality of personal computing devices booking request information indicative of a request for child care from the start time of the cancelled booking, the processor subsequently modifying booking data stored in memory using the booking request information.

2. A method defined by claim 1 wherein the booking for child care is for child care at a child care center.

3. A method defined by claim 2 wherein the availability information is indicative of child care so made available at the child care center from the start time of the cancelled booking.

4. A method defined by claim 3 wherein the booking request information indicative of a request for child care is indicative of a request for child care at the child care center.

5. A method defined by claim 4 wherein the processor subsequently modifies child care center booking data in memory using the booking request information to indicate that a user of the one of the plurality of personal computing devices has booked child care at the child care center from the start time of the cancelled booking and so filled the child care made available by the cancelation of the booking.

6. A method defined by claim 1 wherein the plurality of personal computing devices are associated with a plurality of children registered with a provider of the child care, and the processor selects the plurality of children from registered child data stored in a memory.

7. A method defined by claim 1 wherein the processor is in communication with another processor, and the step of the processor subsequently modifying the booking data comprises the processor modifying booking data in the memory of the other processor.

8. A method defined by claim 7 wherein the processor and the other processor are in communication via an application program interface (API).

9. A method defined by claim 1 wherein the booking data is child care center booking data indicative of a period in which child care is provided at the child care center and a plurality of people booked for child care during the period at the child care center.

10. A processor for managing a booking for child care, the processor comprising at least one microprocessor, a memory, and a communications interface for providing access to a communications conduit, the memory comprising instructions executable by the at least one microprocessor such that the processor is operable to:
receive via the communications interface booking cancelation information, the booking cancelation information being indicative of cancelation of the booking for child care;
send to a plurality of personal computing devices via the communications interface child care availability information indicative of the availability of child care from the start time of the cancelled booking;
receive from one of the plurality of personal computing devices via the communications interface booking request information indicative of a request for child care from the start time of the cancelled booking for child care; and
modify booking data stored in at least one of the memory and another memory using the booking request information.

11. A processor defined by claim 10 wherein the booking for child care is for child care at a child care center.

12. A processor defined by claim 11 wherein the booking cancelation information is indicative of cancelation of the booking for child care at the child care center.

13. A processor defined by claim 12 wherein the cancellation of the booking makes available child care at the child care center.

14. A processor defined by claim 13 wherein the child care availability information is indicative of child care so made available at the child care center from the start time of the cancelled booking.

15. A processor defined by claim 14 wherein the booking data is child care center booking data.

16. A processor defined by claim 15 wherein the child care center booking data is modified to indicate that a user of the one of the plurality of personal computing devices has booked child care at the child care center from the start time of the cancelled booking and so filled the child care made available by the cancellation of the booking.

17. A processor defined by claim 10 wherein the booking data is child care center booking data indicative of a period in which child care is provided at the child care center and a plurality of people booked for child care during the period at the child care center.
